(19) United States
(12) Patent Application Publication
(10) Pub. No.: US 2025/0042198 A1
(43) Pub. Date: Feb. 6, 2025

(54) MULTI-WHEEL CASTERS

(71) Applicant: KARSTEN MANUFACTURING CORPORATION, Phoenix, AZ (US)

(72) Inventors: Bernardo L. Barea Lopez, Phoenix, AZ (US); Dylan R. Cappello, Charlotte, NC (US); Jordan D. Shoenhair, Scottsdale, AZ (US); John A. Solheim, Phoenix, AZ (US); Justin A. Paselk, Phoenix, AZ (US)

(73) Assignee: KARSTEN MANUFACTURING CORPORATION, Phoenix, AZ (US)

(21) Appl. No.: 18/791,317

(22) Filed: Jul. 31, 2024

Related U.S. Application Data
(60) Provisional application No. 63/516,831, filed on Jul. 31, 2023.

(51) Int. Cl. B60B 33/00

(52) U.S. Cl. CPC B60B 33/0036; B60B 33/0005; B60B 33/0049; B60B 2900/1216; B60B 2900/551

(57) ABSTRACT

Multi-wheel casters designed to traverse various obstacles are described herein. The multi-wheel casters can be used in various applications to transport various loads from a first location to a second location. The multi-wheel casters can be rotatable about a king pin to provide maneuverability or can be fixed about a king pin to provide beneficial straight-line transportation. A combination of identical and different casters can be used to create different load transportation platforms.

### TECHNICAL FIELD

This disclosure relates generally to wheel implements and more particularly to casters.

### BACKGROUND

Casters are generally known for facilitating transport of a load by enabling a support by rolling to carry the load. The load can range from heavy machinery, household appliances, or any type of object that needs to be transported across a surface. For example, casters can be often provided on a dolly, where an object can be placed on top of the dolly and wheeled from a first location to a second location. While casters promote mobility of loads, they can be limited when used on discontinuous or uneven surfaces, such as cracks, contraction joints, expansion joints, control joints, and bumps. When a caster traverses such uneven terrain, the impact between the wheels and the discontinuous surface may cause detrimental effects, such as impeding progress, generating noise, and imparting forces that may cause loss of control of the load, including flipping and crashing the load. Thus, it would be advantageous to provide a caster that minimizes wheel interactions with noncontinuous and uneven surfaces.

### BRIEF DESCRIPTION OF THE DRAWINGS

FIG. 1 illustrates a perspective view of a multi-wheel caster according to one embodiment.

FIG. 2 illustrates an exploded perspective view of the caster of FIG. 1.

FIG. 3 illustrates a perspective view of a fork of the caster a of FIG. 1.

FIG. 4 illustrates an exploded top plan view of the caster of FIG. 1, with some components removed for clarity.

FIG. 5 illustrates a top plan view of the caster of FIG. 1.

FIG. 6 illustrates a top plan view of a wheel set of the caster illustrated in FIG. 1, showing an attack angle of the caster.

FIG. 7 illustrates a top plan view of a wheel set of the caster of FIG. 1, showing an attack angle of the caster approaching an obstacle at a particular approach angle.

FIG. 8 illustrates a top plan view of the wheel set of FIG. 7; showing the caster approaching an obstacle at a different approach angle.

FIG. 9 illustrates a to plan view of the caster of FIG. 2, showing dimensions and spacing of the wheel set.

FIG. 10 illustrates a side elevation view of the caster of FIG. 1, showing axle offset dimensions and spacing of the wheel set.

FIG. 11 illustrates a side elevation view of the caster of FIG. 1, showing dimensions and spacing of the wheel set arranged in a first position.

FIG. 12 illustrates a side elevation view of the caster of FIG. 1, showing dimensions and spacing of the wheel set arranged in a second position.

FIG. 13 illustrates a side elevation view of the wheel set of FIG. 11, with the wheels removed, arranged in the first position.

FIG. 14 illustrates a side elevation view of the wheel set of FIG. 12, with the wheels removed, arranged in the second position.

FIG. 15 illustrates an exploded perspective view of the caster of FIG. 1, showing a fork and base plate assembly.

FIG. 16 illustrates a perspective view of a multi-wheel caster according to another embodiment.

FIG. 17 illustrates an exploded perspective view of the caster of FIG. 16.

FIG. 18 illustrates a top view of the caster of FIG. 16.

FIG. 19 illustrates a side view of the caster of FIG. 16.

FIG. 20 illustrates a perspective view of a multi-wheel caster according to another embodiment.

FIG. 21 illustrates an exploded perspective view of the caster of FIG. 20.

FIG. 22 illustrates a top view of the caster of FIG. 20.

FIG. 23 illustrates a top view of the caster of FIG. 20 depicting various angles.

FIG. 24 illustrates a perspective view of a multi-wheel caster according to another embodiment.

FIG. 25 illustrates an exploded perspective view of the caster of FIG. 24.

FIG. 26 illustrates a top view of the caster of FIG. 20.

FIG. 27 illustrates a top view of the caster of FIG. 20 depicting various angles.

### DETAILED DESCRIPTION

Described herein is a multi-wheel caster configured to smoothly traverse loads over/across discontinuous surfaces, such as rough or uneven terrain. The multi-wheel caster improves arranges auxiliary wheels and primary wheels to alter an attack angle as the caster traverses discontinuous surfaces. The attack angle and an offset distance between the primary wheels and auxiliary wheels of the caster wheels combine to minimize shock associated with interactions between the wheels and obstacles or discontinuous surfaces. A plurality of identical casters, or a mix of casters, may be coupled to the support structure carrying a load. Each caster may include a wheel set, a fork to coordinate the wheel set(s), and a baseplate. The wheel set includes one or more primary wheels, one or more auxiliary wheels, and a rotatable level arm connected to the primary and auxiliary wheels. The auxiliary wheels are affixed to front and rear ends of the rotatable level arm, which in some embodiments changes elevation of the auxiliary wheels as the level arm rotates. Alternatively, the auxiliary wheels can be affixed to separate, dedicated level arms. In some embodiments, the caster further comprises a stopping flange provided on the level arm that limits rotation of the level arm. The attack angle of the caster is formed by the configuration of the wheels in each wheel set. Specifically, the spatial arrangement of the auxiliary wheel(s) relative to the primary wheel in lateral and longitudinal directions defines the attack angle. The wheel arrangement and attack angle allow the caster to smoothly traverse obstacles on approach from a wide range of directions.

The multi-wheel caster can be used in a variety of applications. For example, in some embodiments, the caster can be used in wheelbarrows, industrial carts, industrial dollies, commercial carts, commercial dollies, hand casters, stack casters, carriages, strollers and/or luggage. Alternatively, the apparatus, methods, and articles of manufactures described herein may be applicable to other types of applications that are in need of a caster or other moving-wheel platform that glides, traverses, and/or maneuvers over obstacles or foreign objects (i.e., rocks, pebbles, cracks, and/or sidewalk contraction joints).

The terms “connect,” “connected,” “connects,” and “connecting” used herein can be defined as joining two or more elements together, mechanically or otherwise. Connecting (whether mechanical or otherwise) can be for any length of time, e.g. permanent or semi-permanent or only for an instant.

The terms “link,” “linked,” “links,” and “linking” used herein can be defined as a relationship between two or more elements where at least one element affects another element. Linking (whether mechanical or otherwise) can be for any length of time, e.g. permanent or semi-permanent or only for an instant.

The terms “secure,” “secured,” “secures,” and “securing” used herein can be defined as fixing or fastening (one or more elements) firmly so that it cannot be moved or become loose. Securing (whether mechanical or otherwise) can be for any length of time, e.g. permanent or semi-permanent or only for an instant.

The terms “couple,” “coupled,” “couples,” and “coupling” used herein can be defined as connecting two or more elements, mechanically or otherwise. Coupling (whether mechanical or otherwise) can be for any length of time, e.g. permanent or semi-permanent or only for an instant. Mechanical coupling and the like should be broadly understood and include mechanical coupling of all types. The absence of the word “removably,” “removable,” and the like near the word “coupled,” and the like does not mean that the coupling in question is or is not removable.

The term or phrase “caster” used herein can be defined as an apparatus that can be attached to an object to aid in the translational movement of said object.

The term or phrase “ground”, “ground surface”, or “rolling surface” used herein can be defined as the surface on which the wheels of the caster typically roll. The ground or rolling surface is considered to be a generally smooth surface during typical operation of the caster. However, at certain locations, the ground or rolling surface can comprise discontinuities or obstacles such as cracks, bumps, expansion joints, or foreign objects that create a portion of the ground or rolling surface that is unsmooth.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. The terms “comprises,” “comprising,” “including,” and “having,” are inclusive and therefore specify the presence of stated items, but do not preclude the presence of other items. As used in this specification, the term “or” includes any and all combinations of one or more of the listed items. When the terms first, second, third, etc. are used to differentiate various items from each other, these designations are merely for convenience and do not limit the items to a particular order or sequence.

In some examples as used herein, the term “approximately” can be used when comparing one or more values, ranges of values, relationships (e.g., position, orientation, etc.) or parameters (e.g., velocity, acceleration, mass, temperature, spin rate, spin direction, etc.) to one or more other values, ranges of values, or parameters, respectively, and/or when describing a condition (e.g., with respect to time), such as, for example, a condition of remaining constant with respect to time. In these examples, use of the word “approximately” can mean that the value(s), range(s) of values, relationship(s), parameter(s), or condition(s) are within ±0.5%, ±1.0%, ±2.0%, ±3.0%, ±5.0%, and/or ±10.0% of the related value(s), range(s) of values, relationship(s), parameter(s), or condition(s), as applicable.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

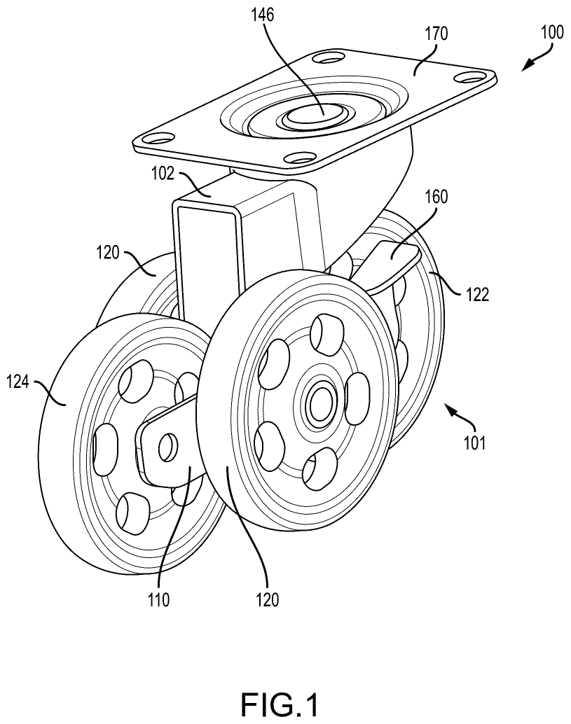

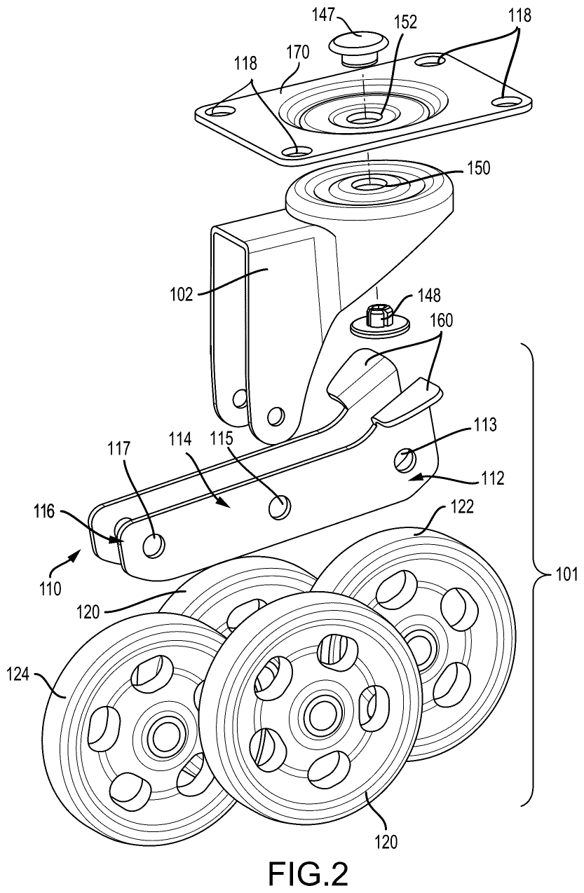

Described below, are embodiments of a general purpose, multi-wheel caster 100 that can be attached to a support structure, such as a dolly. FIGS. 1-2 illustrate an embodiment of the caster 100 comprising an attack angle α that allows the caster 100 to smoothly pass over discontinuous surfaces. In general, the caster 100 comprises a wheel set 101, a fork 102, and a baseplate 170. The baseplate 170 comprises mounting apertures 118 to secure the caster to a load, dolly, or another load bearing structure. The wheel set 101 can include one or more primary wheels 120, and one or more auxiliary wheels 122, 124 coupled to at least one level arm 110. The caster 100 further comprises a fork 102 that connects the wheel set 101 to the baseplate 170. The fork 102 can be rotatably coupled to the baseplate 170 by a rotation assembly 140, thereby to aid in turning the caster to change directions while in use, and a baseplate 170. The rotation assembly 140 and the baseplate 170 will be described in greater detail below. In some embodiments, the caster 100 does not rotate about a king pin and can be fixed in one direction to provide a unidirectional travel direction for the caster 100. A longitudinal axis 1000 extends from a first prong 104 of the fork 102 to a second prong 106 of the fork 102 through a middle bore 115 center as best shown in FIG. 6. The first prong 104 and the second prong 106 comprise a first prong lower end 169a and a second prong lower end 169b.

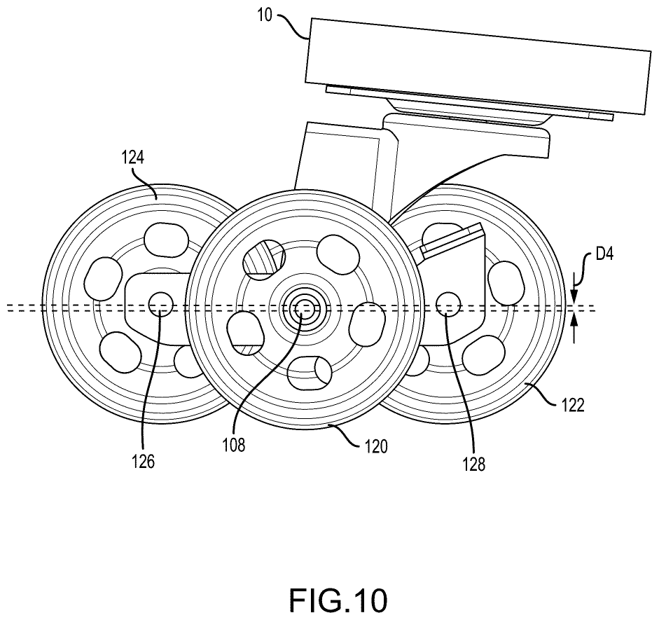

To facilitate rotation of the caster 100 about the king pin 146, and to maintain the lifting effect of the caster, the leading auxiliary wheel 122 and the trailing auxiliary wheel 124 can have a center that is offset a distance D4 from the central axle 108 taken perpendicular from the ground surface. The offset distance D4 can be greater than or equal to 0.03 inch and less than or equal to 0.12 inch. Referring to FIG. 10, the offset distance D4 is shown for reference. This allows for the leading auxiliary wheel 122 and the trailing auxiliary wheel 124 to discontinuously engage with the ground surface. The offset distance D4 promotes rotation of the caster about the king pin 146 by removing the leading auxiliary wheel 122 and the trailing auxiliary wheel 124 to not bear the load when the caster is traveling along a smooth surface. The offset distance allows the leading auxiliary wheel 122 and the trailing auxiliary wheel 124 to selectively engage an obstacle and the ground surface when the caster 100 encounters an obstacle.

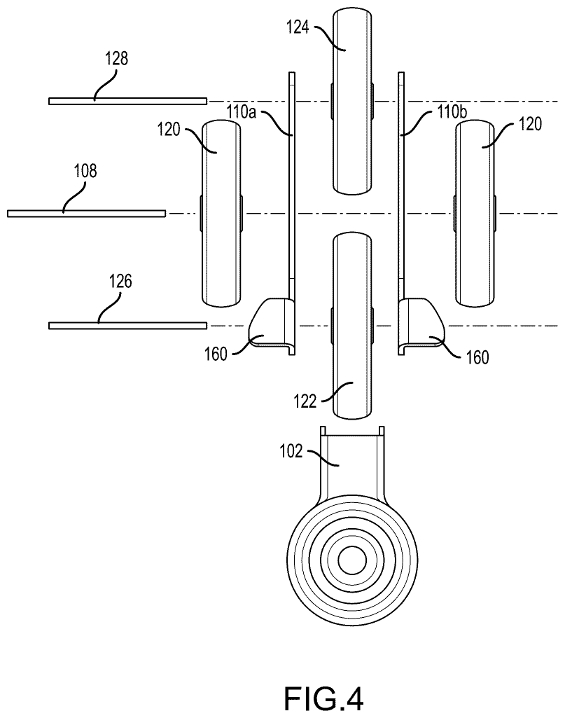

The wheel sets 101 absorb unwanted shock upon impact with an obstacle and provides a smooth ride over rough terrain. FIG. 4 illustrates an example of a wheel set 101 according to the present disclosure. In this example, the wheel set 101 comprises the level arm 110 coupled to a central axle 108, and at least one primary wheel 120 rotatably coupled to the central axle 108. Additionally, the wheel set 101 includes two auxiliary wheels 122, 124 coupled to the level arm 110 by auxiliary axles 126, 128. In some embodiments, each wheel set comprises one primary wheel 120 and two auxiliary wheels, including a leading auxiliary wheel 122 and a trailing auxiliary wheel 124.

The fork 102 provides support to the at least one level arm(s) 110 and the at least one primary wheel(s) 120. The fork 102 comprises an upper seat 130 configured to be rotatably coupled to the baseplate 170. The fork 102 further comprises middle bores 115 that extend through both the first prong 104 and the second prong 106 and are aligned with each other. The middle bores 115 are sized to receive the central axle 108. The central axle 108 can be inserted through the fork 102, via the middle bores 115, and configured to affix thereto both the primary wheel(s) 120 and the level arm 110. In some embodiments, the primary wheels 120 also include a bore sized to receive the central axle 108 while permitting free rotation of the wheels, allowing the caster 100 to smoothly and securely roll along the primary wheel 120 during use.

The level arm 110 is operatively coupled to the wheels and pivots to change elevation of the auxiliary wheels relative to the primary wheel. More specifically as best shown in FIGS. 10-12, the level arm is rotatably coupled to the central axle 108, to connect the leading and trailing auxiliary wheels 122, 124 to the fork 102; thereby allowing the leading and trailing auxiliary wheels 122, 124 to rise and fall while rotating about the central axle 108. The level arm 110 coordinates and forms an attack angle for the leading auxiliary wheel and the trailing auxiliary wheels 122, 124 in front of and behind the primary wheel(s) 120. In some embodiments with reference to FIGS. 1 and 2, the level arm 110 may be a split level arm that includes a first level arm member 110a and a second level arm member 110b abutting opposing inner surfaces of the fork. The level arm 110 comprises a first end 112 disposed near the front of the caster 100 (i.e., the portion of the caster 100 nearest the front of the fork/the side towards the intend path of travel), a second end 116 opposite the first end 112 and disposed near the back of the caster 100, and a central region 114 disposed between the first end 112 and the second end 116. The central region 114 comprises the middle bore 115 located substantially at the center of the level arm 110 and configured to concentrically link, attach, and/or couple the central axle 108. In some embodiments the middle bore 115 can be offset a distance from the center of the level arm to enable the leading auxiliary wheel 122 to be closer or further to the central wheel 120 or the trialing auxiliary wheel 124 to be closer or further to the central wheel 120. This allows for the leading auxiliary wheel 124 or the auxiliary trailing wheel to reach further over a crack or over a bump than the other. The middle bore 115 allows the level arm 110 to couple to and rotate about the central axle 108.

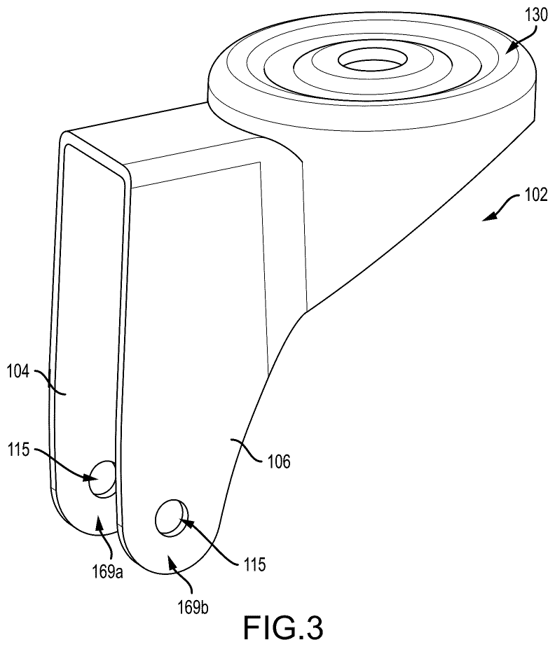

The auxiliary wheels are attached at either end of the level arm 110 by a plurality of auxiliary axles 126, 128. As illustrated in FIG. 3, the first end 112 is configured to receive a leading auxiliary wheel 122. The first end 112 comprises a first bore 113 configured to concentrically link, attach, and/or couple a first auxiliary axle 126 (hereafter “front axle”). The front axle 126 is fixedly coupled within the first bore 113 so that the front axle 126 is restricted from rotating with respect to the level arm 110. The leading auxiliary wheel 122 is coupled to the front axle 126 and allowed to freely rotate upon said front axle 126. As shown in FIG. 3, the second end 116 is configured to receive a trailing auxiliary wheel 124. The second end 116 comprises a second bore 117 configured to concentrically link, attach, and/or couple a rear auxiliary axle 128 (hereafter “rear axle”). The rear axle 128 is fixedly coupled within the second bore 117 so that the rear axle 128 is restricted from rotating with respect to the level arm 110. The trailing auxiliary wheel 124 is affixed to and freely rotates upon said rear axle 128. The leading auxiliary wheel and trailing auxiliary wheels 122, 124 are attached to either end of the level arm 110 by the plurality of auxiliary axles 126, 128. This configuration allows the leading and trailing auxiliary wheels 122, 124 to roll freely along the ground during use of the caster. The location of the auxiliary axles 126, 128 to which the leading and trailing auxiliary wheels 122, 124 are attached allows the leading and trailing auxiliary wheels 122, 124 to move up or down as the level arm 110 rotates about the central axle 108.

As the caster 100 encounters uneven terrain, the ability of the leading and trailing auxiliary wheels 122, 124 to move relative to the primary wheel(s) 120 creates a system “lifting effect” that enables the caster 100 to smoothly roll over uneven terrain. More specifically, the level arm 110 rotates in response to discontinuities in the surface causing the auxiliary wheels (e.g., the leading and trailing auxiliary wheels 122, 124) on either of the level arm 110 ends, or along the level arm 110, to raise or lower to an active position. The active position of the auxiliary wheels reduces the deceleration of the central axle 108 and the shock to the load 10, shown schematically in FIG. 10, when the caster 100 encounters uneven terrain. The level arm 110 rotation creates vertical translation of the auxiliary wheels that allow at least one of the caster multiple wheels to remain in contact with the ground.

The lifting effect/active position also dynamically distributes load 10 between the primary and auxiliary wheels during use to provide a smooth roll. During normal use of the caster 100 across a smooth surface, the primary wheel 120 can support a majority of the load 10 applied to the caster 100. However, when the primary wheel 120 encounters an obstacle, such as a crack, the leading auxiliary wheel 122 and/or the trailing auxiliary wheel 124 can bear the majority of the load 10 to keep the caster 100 stable due to the offset as described above. As the leading auxiliary wheel 122 encounters the crack before the primary wheel(s) 120, the level arm 110 rotates to lower the leading auxiliary wheel 122 into the crack. Meanwhile, most of the load 10 is supported by the primary wheel 120, which continues to roll along the smooth rolling surface. As the leading auxiliary wheel 122 exits the crack, and the primary wheel 120 enters the crack, the level arm 110 rotates to raise the leading auxiliary wheel 122 out of the crack and allow it to continue rolling along the smooth rolling surface. Rather than descending into the crack, causing deceleration of the caster 100 or shock to the load 10, the primary wheel 120 is suspended over the crack by the leading and trailing auxiliary wheels 122, 124 coupled to the level arm 110. Because the leading and trailing auxiliary wheels 122, 124, both engage the smooth rolling surface, substantially the entire load 10 is supported between the auxiliary wheels, and little to none of the load 10 is carried by the primary wheel 120. As the primary wheel 120 exits the crack, the trailing auxiliary wheel 124 can enter the crack, and the level arm 110 rotates to lower the trailing auxiliary wheel into the crack. Meanwhile, most of the load 10 is supported by the primary wheel 120, which is once again rolling along the smooth rolling surface. Because at least one wheel engages the smooth rolling surface and supports most of the load 10 at any given time, the caster 100 experiences less shock as it traverses uneven terrain.

A spatial arrangement between the plurality of wheels allows the caster 100 to smoothly traverse obstacles and discontinuous surfaces. The spatial arrangement of the wheels enables the lifting effect to occur regardless of the angle at which the caster 100 encounters an obstacle. In some embodiments, the primary wheels 120 and auxiliary wheels 122, 124 are spaced apart, both laterally (i.e., with respect to a direction extending along the longitudinal axis 1000) and longitudinally (i.e., in a front-to-rear direction). This spatial arrangement of the wheels provides the caster 100 with a wide base and prevents the wheels within each given wheel set from all impacting an obstacle simultaneously. Therefore, there is always at least one wheel of every given wheel set supporting the load 10 weight on the main rolling surface at any given time. The spatial relationship between the wheels within a given wheel set can be characterized by an attack angle α, described in detail below.

The attack angle α is a characteristic of the spatial relationship between the primary wheel 120 and auxiliary wheels of the caster 100. As shown in FIG. 6, the attack angle α can be defined as the included angle between a first reference line A connecting the primary wheel 120 and the leading auxiliary wheel 122 of a particular wheel set and a second reference line B extending parallel to the longitudinal axis 1000. The first reference line A can connect a first reference point R1 located on the leading auxiliary wheel 122 and a second reference point R2 located on the primary wheel 120. The first reference point R1 is the forwardmost and outermost (i.e., furthest spaced away from the fork 102) point of the leading auxiliary wheel 122. Similarly, the second reference point R2 is the forwardmost and outermost point of the primary wheel 120. Different configurations of the leading and primary wheel 120 can alter the relationship between the first and second reference point R1, R2, thus altering the directionality of the first reference line A.

The attack angle α relates the position of the first and second reference points R1, R2. The attack angle α is dependent on the size and location of the primary wheel 120 and the leading auxiliary wheel 122. Specifically, different attack angles α are formed upon differences in (1) the lateral spacing between the primary wheel 120 and leading auxiliary wheel 122, (2) the front-to-rear spacing between the primary wheel 120 and leading auxiliary wheel 122, (3) the widths of the primary wheel 120 and leading auxiliary wheel 122, and (4) the diameters of the primary wheel 120 and leading auxiliary wheel 122. In this way, the attack angle α can be manipulated by changing the spatial relationship between the leading and primary wheels 120 and/or by altering the diameter and/or width of the leading auxiliary wheel 122 and primary wheel 120. For example, providing a greater lateral distance between the leading auxiliary wheel 122 and the primary wheel 120 creates an attack angle α that is shallower (i.e., closer to 60 degrees). In contrast, providing a smaller lateral distance between the leading auxiliary wheel 122 and the primary wheel 120 creates an attack angle α that is steeper (i.e., closer to 30 degrees). Similarly, altering the diameter and/or width of one or more wheels within the wheel set changes the location of the first reference point R1 and/or second reference point R2, which in turn alters the orientation of the first reference line A. Embodiments of a plurality of wheels having desired diameters and widths, for the appropriate attack angle α are described below.

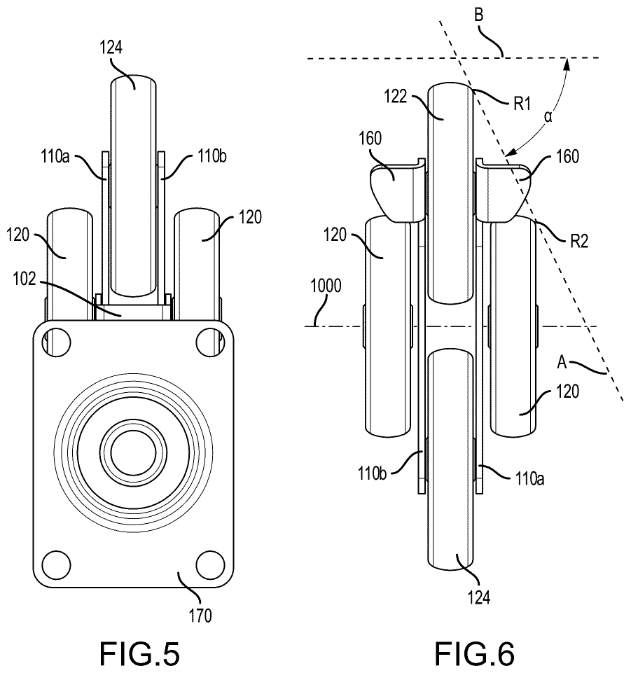

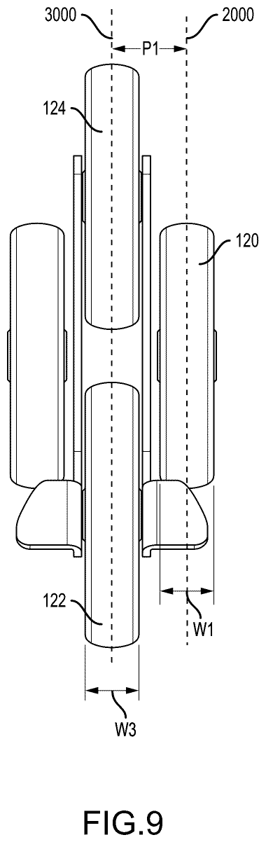

In some embodiments, the primary wheel 120 is laterally spaced away from the plurality of auxiliary wheels to create the attack angle α. In general, the plurality of auxiliary wheels comprise an “inline” configuration, in which the leading and trailing auxiliary wheels 122, 124 are positioned in a straight line from the front of the caster 100 to the rear. The primary wheel 120 is not in line with respect to the auxiliary wheels, but rather is laterally offset from the auxiliary wheels. The fork provides the necessary offset of the primary wheel 120 from the auxiliary wheels. For example, as illustrated by FIG. 5, the primary wheel 120 is laterally spaced further from the fork 102 than the auxiliary wheels, such that the auxiliary wheels are located between the primary wheel 120 and the fork 102. The primary wheels can be offset by approximately at least one half of the wheel width in the lateral direction. In alternative embodiments, the primary wheel 120 can be laterally spaced closer to the fork 102 than the auxiliary wheels, such that the primary wheel 120 is located between the auxiliary wheels and the fork 102. The lateral spacing can be characterized by the distance between a pair of planes between the auxiliary wheels, in particular the leading auxiliary wheel 122 and the primary wheel 120, and with respect to one another. The leading auxiliary wheel 122 and primary wheel 120 can each sit upon a respective plane separated by a particular distance in a longitudinal direction. FIG. 9 illustrates a first plane 2000 extending in a front-to-rear direction through the center of the primary wheel 120. Similarly, a second plane 3000 is illustrated, wherein the second plane 3000 extends in a front-to-rear direction (thus parallel to the first plane 2000) through the center of the leading auxiliary wheel 122. In some embodiments, the distance P1 between the first plane 2000 and the second plane 3000 is approximately 2.0 inches. In some embodiments, the distance P1 between the first plane 2000 and the second plane 3000 can range approximately between 0.5 inches and 3.0 inches. In some embodiments, the distance P1 between the first plane 2000 and the second plane 3000 ranges approximately between 0.5 inches and 1.0 inches, approximately between 1.0 inches and 1.5 inches, approximately between 1.5 inches and 2.0 inches, between approximately 2.0 inches and 2.5 inches, or approximately between 2.5 inches and 3.0 inches. The distance P1 can be 0.5, 0.6, 0.7, 0.8, 0.9 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 inches. The distance between the first plane 2000 and the second plane 3000 create a wheel set in which the primary wheel 120 is laterally spaced from the auxiliary wheels. This configuration creates the desired attack angle α and a wide base for the wheel set.

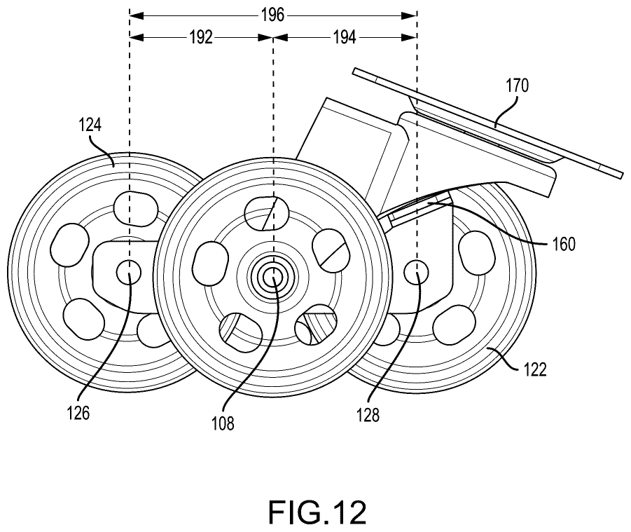

The attack angle α is further determined by a front-to-rear, or longitudinal distance between adjacent wheels. FIG. 12 illustrates a front-to-rear distance 192 defined between the leading auxiliary wheel 122 and the primary wheel 120, wherein the rear distance 192 is measured as the perpendicular distance between the axles (i.e., the front axle 126 and the central axle 108) upon which each wheel is attached. Similarly, a front-to-rear distance 194 between the primary wheel 120 and the trailing auxiliary wheel 124 can be measured as the perpendicular distance between the central axle 108 and the rear axle 128, upon which each respective wheel is attached. In some embodiments, the front-to-rear distance 192, 194 between adjacent wheels is dependent on the front-to-rear length of the level arm 110, as the leading and trailing auxiliary wheels 122, 124 are affixed proximate either end of the level arm 110.

The leading auxiliary wheel 122/first auxiliary wheel can be located approximately between one eighth and seven eighths of the leading auxiliary wheel 122 diameter in front of the primary wheel. The leading auxiliary wheel 122 can be located approximately two thirds of the leading auxiliary wheel 122 diameter in front of the primary wheel. The leading auxiliary wheel 122 can be located approximately one eighth, one seventh, one sixth, one fifth, one fourth, one third, one half, two sevenths, two fifths, two thirds, three eighths, three sevenths, three fifths, four sevenths, or four fifths of the leading auxiliary wheel 122 diameter in front of the primary wheel.

The trailing auxiliary wheel 124/second auxiliary wheel can be located approximately between one eighth and seven eighths of the trailing auxiliary wheel 124 diameter behind the primary wheel. The trailing auxiliary wheel 124 can be located approximately two thirds of the trailing auxiliary wheel 124 diameter behind the primary wheel. The trailing auxiliary wheel 124 can be located approximately one eighth, one seventh, one sixth, one fifth, one fourth, one third, one half, two sevenths, two fifths, two thirds, three eighths, three sevenths, three fifths, four sevenths, or four fifths of the trailing auxiliary wheel 124 diameter behind the primary wheel.

In some embodiments, the front-to-rear distance between any adjacent pair of wheels can be approximately 1.5 inches. In some embodiments, the front-to-rear distance between any adjacent pair of wheels can be between approximately 0.5 and 3.5 inches. In some embodiments, the front-to-rear distance between adjacent wheels can be between 0.5 and 1.0 inches, between 1.0 and 1.5 inches, between 1.5 and 2.0 inches, or between 2.0 and 2.5 inches. In some embodiments, the front-to-rear distance between adjacent wheels can be between 0.5 and 0.75 inches, between 0.75 and 1.0 inches, between 1.0 and 1.25 inches, between 1.25 and 1.5 inches, between 1.5 and 1.75 inches, between 1.75 and 2.0 inches, between 2.0 and 2.25 inches, between 2.25 and 2.5 inches, between 2.5 inches and 3.0 inches, or between 3.0 inches and 2.5 inches. The front-to-rear distance 192 can be, 0.5, 0.6, 0.7, 0.8, 0.9 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, or 3.5 inches. In some embodiments, the front-to-rear distance 192 between the leading auxiliary wheel 122 and the primary wheel 120 can be substantially similar to the front-to-rear distance 194 between the primary wheel 120 and the trailing auxiliary wheel 124. In other embodiments, the front-to-rear distance 192 between the leading auxiliary wheel 122 and the primary wheel 120 can substantially differ from the front-to-rear distance 194 between the primary wheel 120 and the trailing auxiliary wheel 124. The front-to-rear distance between adjacent wheels determines, in part, the location of the first reference point R1 and the second reference point R2, and therefore influences the attack angle α.

The configuration of the primary wheel 120 and the leading auxiliary wheel 122, both in terms of spacing and dimensions of each wheel, define the attack angle α for the caster 100. In some embodiments, an attack angle α between 30 and 60 degrees is desirable to allow the caster 100 the ability to smoothly traverse obstacles at the widest range of angles. In some embodiments, the attack angle α of the caster 100 is approximately 45 degrees. In some embodiments, the attack angle α is between approximately 30 degrees and 60 degrees. In some embodiments, the attack angle α is between approximately 30 and 35 degrees, between approximately 35 and 40 degrees, between approximately 40 degrees and 45 degrees, between approximately 45 degrees and 50 degrees, between approximately 50 degrees and 55 degrees, or between approximately 55 degrees and 60 degrees. In other embodiments, the attack angle α is between approximately 30 and 32 degrees, between approximately 32 and 34 degrees, between approximately 34 and 36 degrees, between approximately 36 and 38 degrees, between approximately 38 and 40 degrees, between approximately 40 degrees and 42 degrees, between approximately 42 degrees and 44 degrees, between approximately 44 degrees and 46 degrees, between approximately 46 degrees and 48 degrees, between approximately 48 degrees and 50 degrees, between approximately 50 degrees and 52 degrees, between approximately 52 degrees and 54 degrees, between approximately 54 degrees and 56 degrees, between approximately 56 degrees and 58 degrees, or between approximately 58 degrees and 60 degrees. The attack angle α can be 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 degrees.

The caster 100 attack angle α can be a bi-lateral external attack angle that is, the caster has two attack angles on opposite sides of the leading wheel, and the angles are measured relative to the outside edges of respective primary wheels. The caster 100 can have: a first attack angle formed between the leading auxiliary wheel and one of the primary wheels; and a second attack angle formed between the leading auxiliary wheel and another primary wheel. The attack angles are external to the caster such that they are formed by a line that is tangential to the exterior of the caster 100 structure.

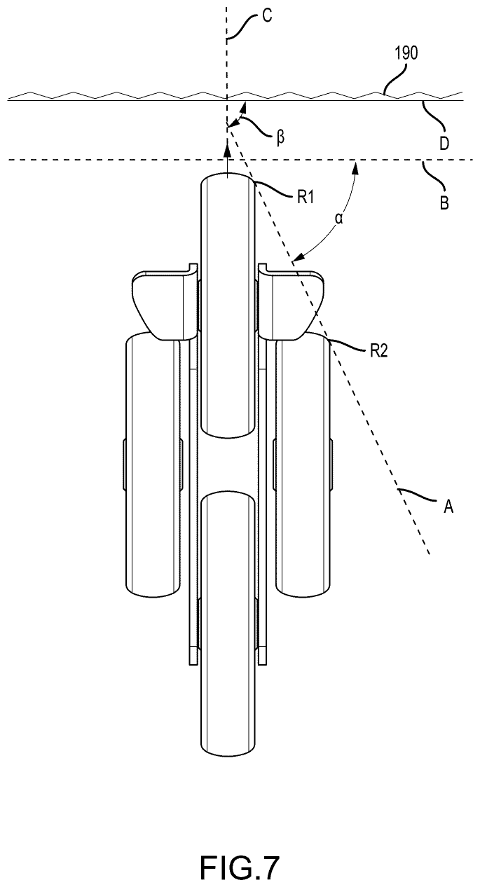

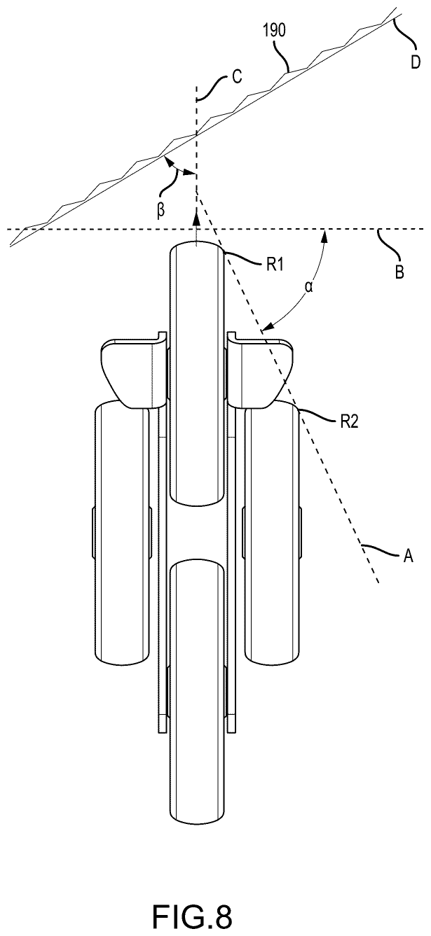

The attack angle α can enhance the ability of the caster 100 to smoothly traverse obstacles of varying size, while approaching such obstacles at a wide range of angles. As shown in FIGS. 7 and 8, an approach angle β can be defined between the caster 100 and an obstacle 190 as the caster 100 approaches the obstacle 190. The approach angle β can be defined as the acute angle between the obstacle 190 and a direction of travel of the caster 100. More specifically, the approach angle β is formed by a reference line C corresponding to the direction of travel at the moment the caster 100 impacts the obstacle 190, and a second reference line D tangent to the obstacle 190 at the point of impact. For example, a caster approaching an elongate obstacle 190 “straight on” would define an approach angle β of approximately 90 degrees, while a caster approaching the obstacle 190 from any direction other than straight on would define an approach angle β less than 90 degrees. For example, the approach angle could be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 degrees.

The attack angle α of the caster 100 allows the caster 100 to smoothly traverse obstacles and discontinuous surfaces at a wider range of approach angles β than a conventional caster. Because the primary wheel 120 and the leading auxiliary wheel 122 are laterally spaced apart to form the attack angle α, the caster 100 essentially comprises a wider base than a similar caster with an in-line wheel configuration or a conventional caster forming no attack angle. The attack angle reduces the likelihood that multiple wheels in the set will impact an obstacle at the same time. This provides balance and stability over obstacles of various sizes and orientations by allowing at least one wheel in each wheel set to contact the regular rolling surface at any given time. In other words, the attack angle α allows the lifting effect to occur at a wide range of approach angles β.

When the caster 100 encounters an obstacle at any approach angle β, the load 10 can be shifted between the primary and auxiliary wheels in both a front-to-rear direction as well as a lateral direction. This configuration provides the caster 100 with more stability than a conventional single wheel caster, due to the ability to transfer the load between multiple wheels when encountering an obstacle. When a conventional caster encounters an obstacle, the weight of the load 10 cannot be shifted from the wheel, and thus the wheel experiences the full force of impact with the obstacle. In contrast, the ability to shift load 10 between a primary wheel 120 and auxiliary wheels allows the caster 100 to absorb the force of impact with the obstacle. The ability to shift load 10 in multiple directions due to the attack angle α of the caster 100 provides a greater absorption of this force over a wider range of approach angles β.

Additionally, an overall span 196 measured from the front axle 126 center to the rear axle 128 center facilitates traversing various obstacle widths. The overall span 196 can be between 1.0 inch and 7.0 inches. Different applications of the caster 100 require different overall spans 196 depending on the obstacles encountered by the caster 100. A greater overall span 196 allows the caster 100 to traverse wider obstacles. However, some applications require the overall span 196 to have a smaller dimension to allow the caster 100 to be more maneuverable. The overall span can be 1.0 inch, 1.5 inches, 2.0 inches, 2.5 inches, 3.0 inches, 3.5 inches, 4.0 inches, 4.5 inches, 5.0 inches, 5.5 inches, 6.0 inches, 6.5 inches, or 7.0 inches. The overall span 196 can be between 1.0 inch and 2.0 inches, 2.0 inches and 3.0 inches, 3.0 inches and 4.0 inches, 4.0 inches and 5.0 inches, 5.0 inches and 6.0 inches, or 6.0 inches and 7.0 inches. The overall span 196 can be less than 1.0 inch, 2.0 inches, 3.0 inches, 4.0 inches, 5.0 inches, 6.0 inches, or 7.0 inches. The overall span 196 can be greater than 1.0 inch, 2.0 inches, 3.0 inches, 4.0 inches, 5.0 inches, 6.0 inches, or 7.0 inches. The overall span 196 affects the lifting effect of the caster changing the vertical distance the leading auxiliary wheel 122 and the trailing auxiliary wheel travel when the level arm 110 rotates about the central axle 108.

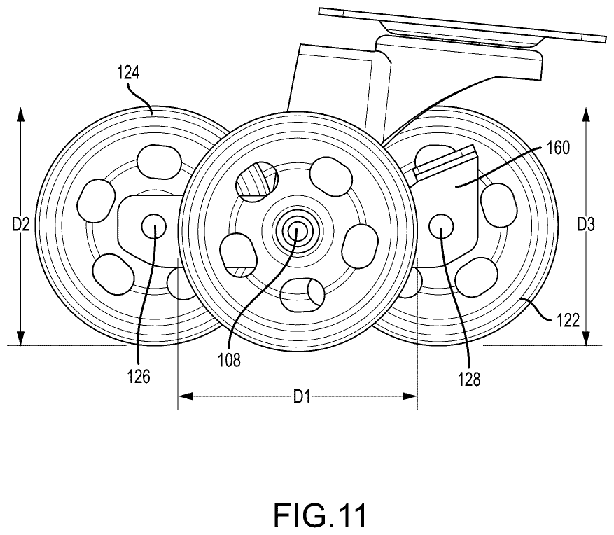

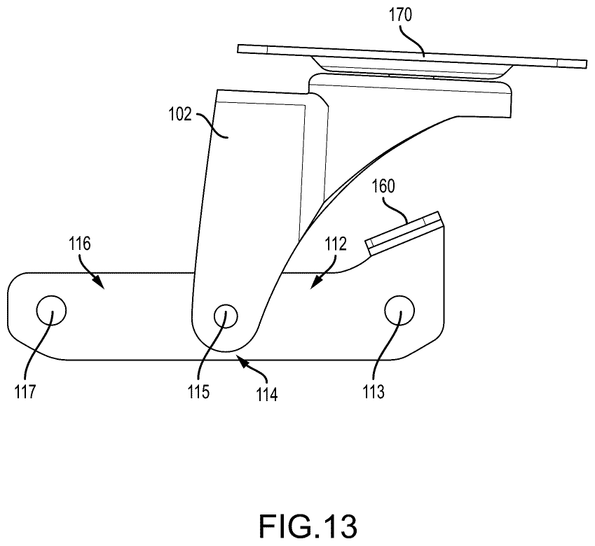

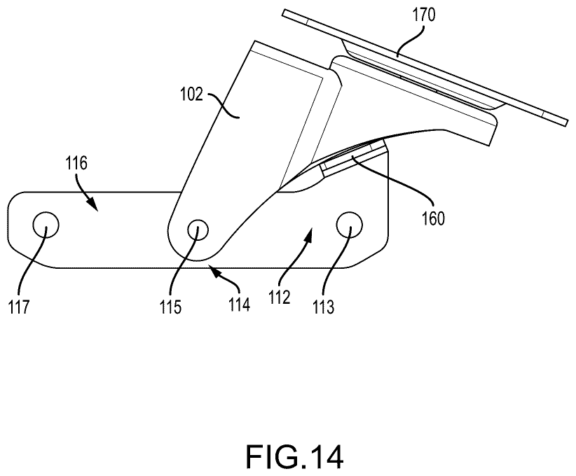

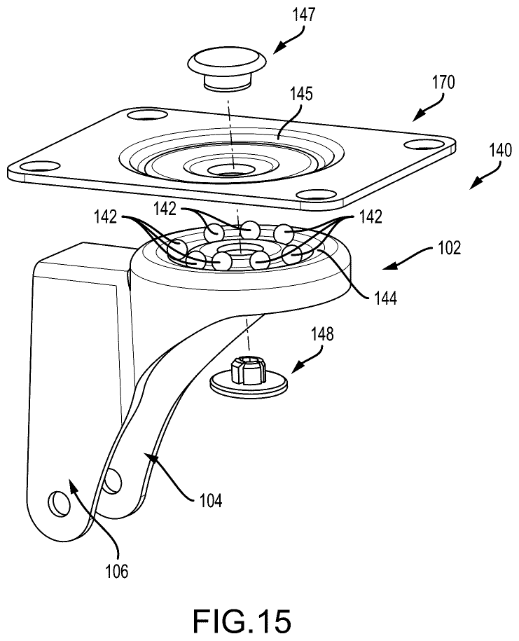

The lifting effect allows the caster 100 to smoothly traverse obstacles due to the lifting of the leading auxiliary wheel 122 and the trailing auxiliary wheel 124 upon the level arm 110 rotating about the central axle 108. In some situations, however, it may be advantageous to limit rotation of the level arm. For example, where over rotation may cause the leading auxiliary wheel 122 or trailing auxiliary wheel to contact the fork 102 or the baseplate 170, limiting rotation may avoid resulting damage or inoperability of the caster 100. Referring to FIGS. 11-14, the level arm 110 can comprise a stopping flange 160 positioned and/or configured to contact the fork 102 in the event the level arm 110 over rotates. The stopping flange 160 can extend from the level arm first end 112 and be perpendicular to the level arm first end 112. The stopping flange 160 prevents rotation of the level arm beyond a rotational limit. Limiting rotation of the level arm 110 prevents the trailing auxiliary wheel 124 from contacting the fork 102 or baseplate 170, which would cease movement along the intended path C or damage the leading auxiliary wheel 122 or the trailing auxiliary wheel 124.

The rotation assembly 140 comprises a fork groove 144, a plurality of ball bearings 142, a king pin 146, and a baseplate groove 145. The fork groove 144 and the baseplate groove 145 are circular in shape and comprise the same diameter. The fork groove 144, the baseplate groove 145, and the king pin 146 are concentric. More specifically, the fork 102 and the baseplate 170 comprises a first through hole 150 and a second through hole 152, respectively, configured to receive the king pin 146. The king pin comprises a top portion 147 and a bottom portion 148. The top portion 147 is inserted through the first through hole 150 and further comprises a receiving geometry that receives the bottom portion 148. The bottom portion 148 is inserted through the second through hole 152 and is inserted into the top portion 147. This creates a mechanical attachment between the fork 102 and the baseplate 170. To allow the fork 102 to rotate about the king pin 146, the plurality of ball bearings 142 (seated within the fork groove 144 and the baseplate groove 145) providing a rotation platform between the fork 102 and the baseplate 170.

To facilitate rotation of the caster 100 about the king pin 146, and to maintain the lifting effect of the caster, the leading auxiliary wheel 122 and the trailing auxiliary wheel 124 can have a center that is offset a distance D4 from the central axle 108. Referring to FIG. 10, the offset distance D4 can be between 0.03-0.12 inch. The offset distance D4 can be greater or equal to 0.03 inch and less than or equal to 0.12 inch. The offset distance D4 can be greater than 0.03, 0.04, 0.05, 0.06, 0.07, 0.08, 0.09, 0.10, 0.11, or 0.12 inch. The offset distance D4 can be less than 0.03, 0.04, 0.05, 0.06, 0.07, 0.08, 0.09, 0.10, 0.11, or 0.12 inch. The offset distance can be 0.03, 0.04, 0.05, 0.06, 0.07, 0.08, 0.09, 0.10, 0.11, or 0.12 inch. This allows for the leading auxiliary wheel 122 and the trailing auxiliary wheel 124 to discontinuously engage with the ground surface. The offset distance raises the leading auxiliary wheel 122 and the trailing auxiliary wheel 124 above the central axle 108. Therefore, when no obstacle is in front of the intended path of travel C, the leading auxiliary wheel 122 and trailing auxiliary wheel 124 do not contact the ground surface allowing for the primary wheels 120 to pivot and the fork 102 to rotate about the king pin 146. When the caster 100 encounters an obstacle, the leading auxiliary wheel 122 and trailing auxiliary wheel 124 engages the ground surface as described above to provide a smooth transition over the obstacle. This arrangement enables engagement over uneven surface but limits engagement if not removes engagement of the auxiliary wheels over a smooth surface.

The leading auxiliary wheel 122 can be located between inclusively one ninth and one one hundred sixty seventh of the leading auxiliary wheel diameter above the primary wheel. The leading auxiliary wheel 122 can be less than, greater than, or equal to, one ninth, one fifteenth, one thirtieth, one sixtieth, one ninetieth, one one hundred twentieth, one one hundred and sixtieth, or one one hundred sixty seventh of the leading auxiliary wheel diameter above the primary wheel 120.

The trailing auxiliary wheel 124 can be located between inclusively one ninth and one one hundred sixty seventh of the leading auxiliary wheel diameter above the primary wheel. The trailing auxiliary wheel 124 can be less than, greater than, or equal to, one ninth, one fifteenth, one thirtieth, one sixtieth, one ninetieth, one one hundred twentieth, one one hundred and sixtieth, or one one hundred sixty seventh of the leading auxiliary wheel diameter above the primary wheel 120.

The leading auxiliary wheel, trailing auxiliary wheel, and primary wheels can be made from a variety of different materials, including polyurethanes or thermoplastic elastomers (TPE). This includes, but is not limited to, phenolics, polyamides, polyvinyl, polyimides, polyolefins, polyethylene, polypropylene, and polyethylene terephthalate. The wheels can further be made out of thermoplastic, thermoset matrices filled with glass spheres, metal particles (i.e. aluminum, copper, steel, etc.), or graphene. The primary wheels, leading auxiliary wheel, and trailing auxiliary wheel can each have a diameter, D1, D2, and D3 between 1.0 inch and 5 inches. D1, D2, and D3 can be greater than, less than, or equal to, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 inches. The primary wheels, leading auxiliary wheel, and trailing auxiliary wheel can have a width, W1, W2, and W3 respectively between 0.3 inch to 2.5 inches. W1, W2, and W3 can be greater than, less than, or equal to, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 inches. The diameters D1, D2, and D3 can be the same dimension or different dimension. The diameters W1, W2, and W3 can be the same dimension or different dimension.

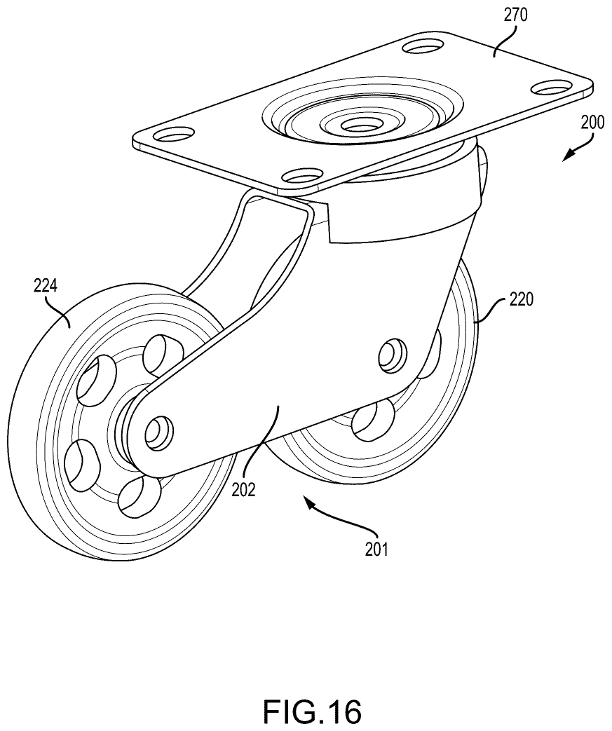

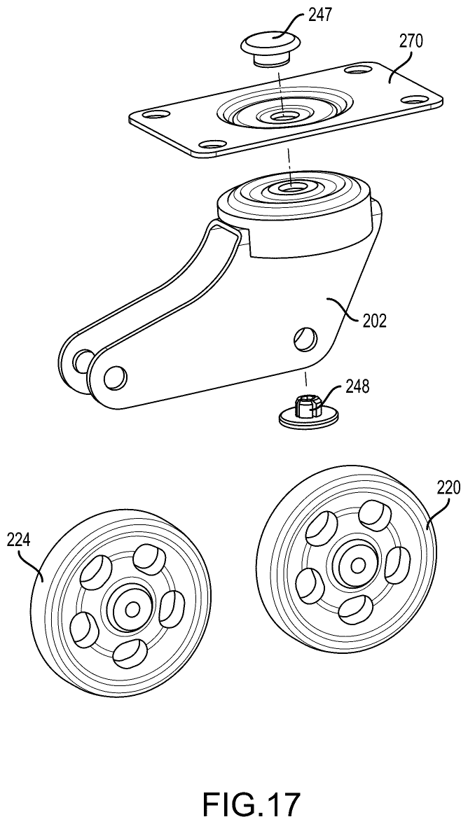

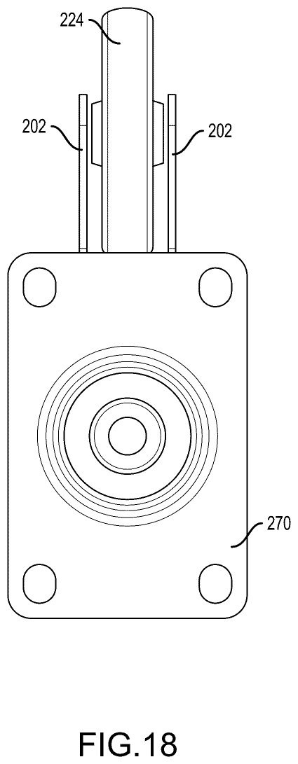

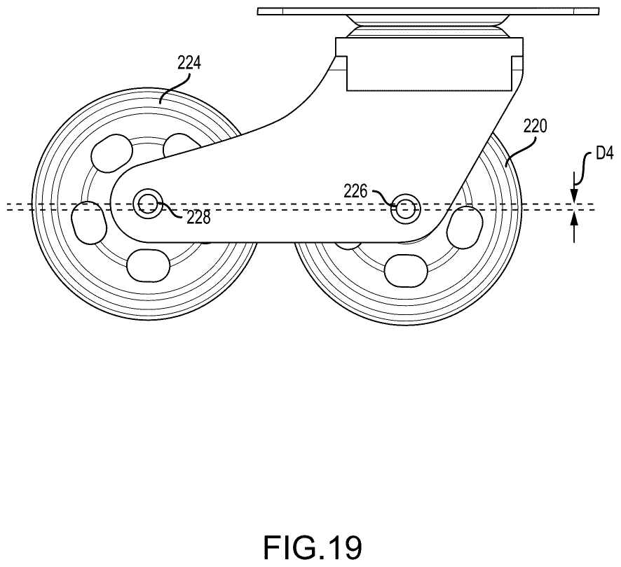

In another embodiment shown in FIGS. 16-19, a caster 200 comprises two wheels, a trailing auxiliary wheel 224 and a primary wheel 220 to create a more maneuverable and pivotable caster. The caster 200 shares the same features and some of the same advantages as caster 100 except for that caster 200 comprises two wheels instead of four. Caster 200 can be used in combination with any of the features described in caster 100. Like caster 100, caster 200 comprises a wheel set 201, a fork 202, the primary wheel 220, the trailing auxiliary wheel 224, a front axle 226, a rear axle 228, a king pin 246, and a base plate 270. All the components of caster 200 function similar to the components of caster 100. The caster 200 is devoid of the level arms as described in caster 100. Instead, the fork 202 extends rearward and receives the trailing auxiliary wheel 224. Therefore, the trailing auxiliary wheel 224 and the primary wheel 220 maintain a constant relationship with each other. The trailing auxiliary wheel 224 and the primary wheel 220 are in line with each other. It is understood that a level arm assembly and wheel set can be used in conjunction with the caster 200. The design of caster 200 with an inline and locked primary wheel 220 and trailing auxiliary wheel 224 creates a maneuverable caster but limits the height and type of obstacles the caster can overcome relative to caster 100. The caster 200 can overcome more obstacles than a single wheel caster.

Caster 200 provides an increase in maneuverability relative to caster 100 through having one primary wheel 220. An offset distance D4 between the front axle 226 and the rear axle 228 provides clearance for the trailing auxiliary wheel 224 such that the primary wheel 220 is the only point of contact with the ground surface for most of the time. When the caster 200 encounters an obstacle, the trailing auxiliary wheel 224 engages the obstacle surface or ground surface depending on the primary wheel 220 location. As described above, when no obstacle is in front of the intended path of travel C, the trailing auxiliary wheel 224 does not contact the ground surface allowing for the primary wheel 220 to pivot and the fork 202 to rotate about the king pin 246. The caster 200 is applicable in a situation where maneuverability is prioritized, and small obstacles are frequently encountered.

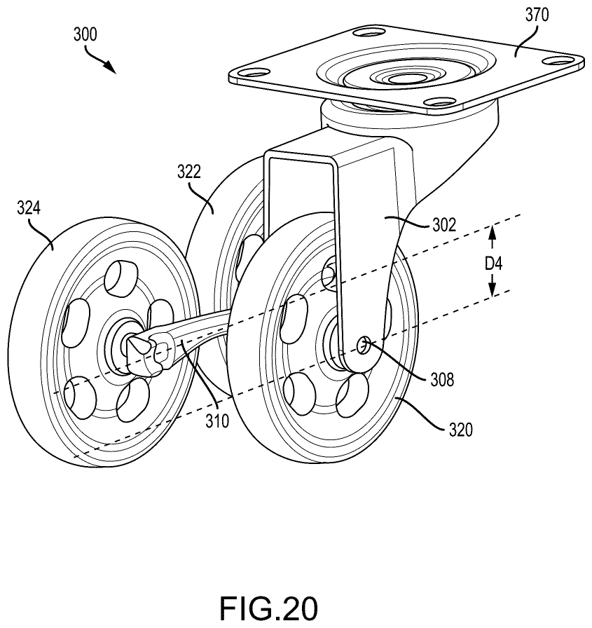

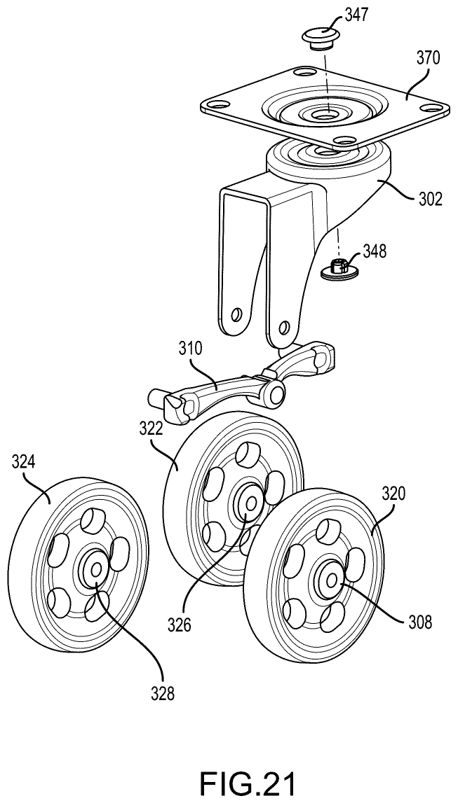

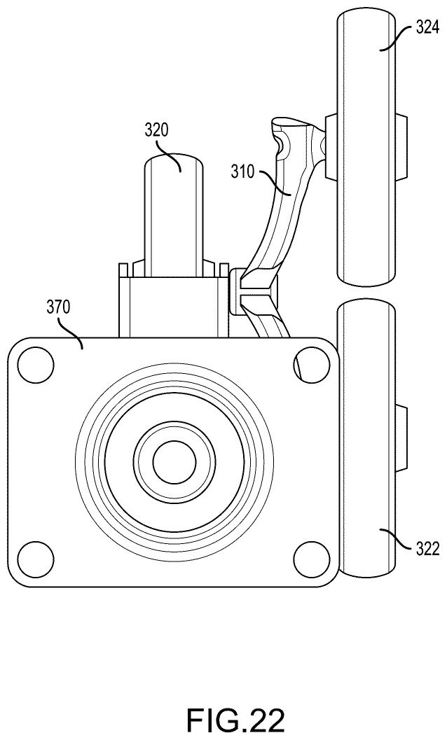

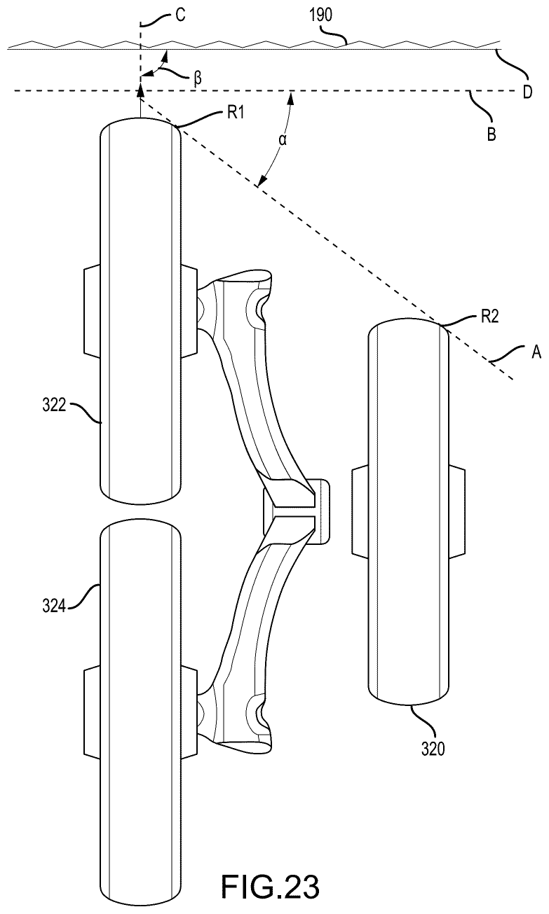

In another embodiment, shown in FIGS. 20-23, a caster 300 comprises three wheels, a leading auxiliary wheel 322, a trailing auxiliary wheel 324, and a primary wheel 320. The caster 300 shares the same features and advantages as caster 100 except for that caster 300 comprises three wheels instead of four. Caster 300 can be used in combination with any of the features described in caster 100. Like caster 100, caster 300 comprises a wheel set 301, comprising the leading auxiliary wheel 322, the trailing auxiliary wheel 324, and the primary wheel 320, a fork 302, a primary axle 308, a front axle 326, a rear axle 328, a level arm 310, a king pin 346, and a base plate 370. The level arm 310 can comprise stopping flanges, as described above, to prevent over rotation of the level arm 310. The caster 300 can be used in various situations.

In some embodiments the caster 300 can rotate about the king pin 346. In some embodiments the caster 300 can be fixed and does not rotate. Therefore, the caster 300 can be used for unidirectional travel. However, using caster 300 in conjunction with the other casters described herein, caster 100, caster 200, and caster 400 can provide different combinations of maneuverability and ability to overcome obstacles.

Like casters 100 and 200, caster 300 can comprise the offset distance D4 to facilitate rotation about the king pin 346. The leading auxiliary wheel 322 and the trailing auxiliary wheel 324 can have a center that is offset a distance D4 from the primary axle 308. As described above, the offset distance D4 allows the leading auxiliary wheel 322 and the trailing auxiliary wheel 324 to only engage the ground when the caster 300 encounters an obstacle, otherwise there is little to no load 10 applied to the leading auxiliary wheel 322 and the trailing auxiliary wheel 324.

Similar to caster 100, caster 300 comprises an attack angle α between 30 and 60 degrees to allow the caster 100 the ability to smoothly traverse obstacles. Caster 300 comprises a unilateral internal attack angle. There is one attack angle α measured between the leading auxiliary wheel 322 and the primary wheel 320. The attack angle is internal to the caster such that is formed by a line that is tangential to the interior side of the caster 300 structure.

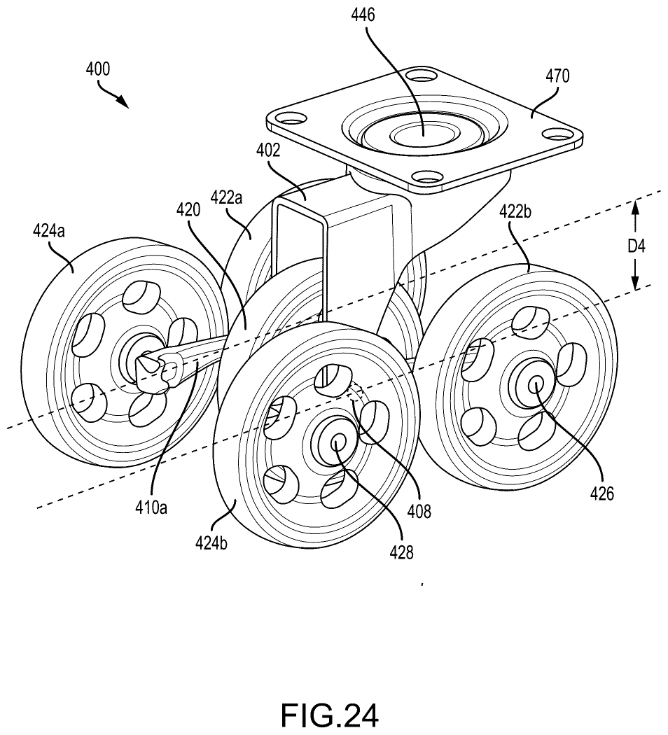

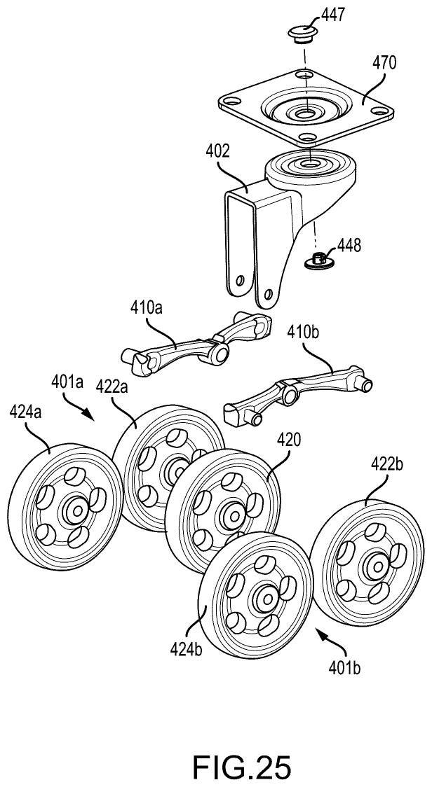

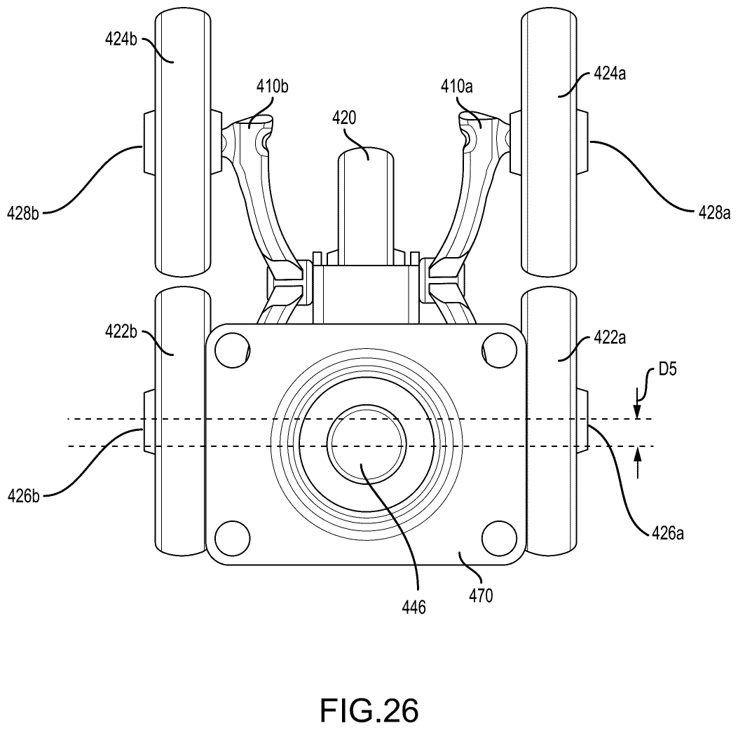

In another embodiment shown in FIGS. 24-27, a caster 400 comprises five wheels, a first leading auxiliary wheel 422a, a second leading auxiliary wheel 422b, a first trailing auxiliary wheel 424a, a second trailing auxiliary wheel 424b, and a primary wheel 420. The caster 400 shares the same features and advantages as caster 100 except for that caster 400 comprises five wheels instead of four. Caster 400 can be used in combination with any of the features described in caster 100. Caster 400 comprises a first wheel set 401a comprising the first leading auxiliary wheel 422a and the first trailing auxiliary wheel 424a, a second wheel set 401b comprising the second leading auxiliary wheel 422b and the second trailing auxiliary wheel 424b. Caster 400 further comprises a fork 402, a first level arm 410a, a second level arm 410b, a first front axle 426a, a second front axle 426b, a first rear axle 428a, a second rear axle 428b, a king pin 446, and a baseplate 470. The level arms 410a and 410b can comprise stopping flanges, as described above, to prevent over rotation. The caster 400 can comprise a central axle 408. Caster 400 can overcome a wide range of obstacles due to the great number of wheels and structural relationships these wheels form.

A distance D5 between the king pin 446 and the first front axle 426a and the second front axle 426b, the central axle 408, or the first rear axle 428a and the second rear axle 428b encourages free rotation of the caster about the king pin. The distance D5 can be approximately between 0.05 inch and 8 inches. The first front axle 426a, the second front axle 426b, the first rear axle 428a, and the second rear axle 428b, or the central axle 408 can be offset a distance D5 behind the king pin 446 relative to the direction of travel C to enable the caster 400 to rotate about the king pin. Casters 100, 200, and 300 can also comprise the offset distance D5. The caster 400 comprising five wheels needs the offset distance D5 to avoid drag as the five wheels rotate about the king pin 446.

Similar to caster 100, caster 400 comprises an attack angle α between 30 and 60 degrees to allow the caster 100 the ability to smoothly traverse obstacles. Caster 400 comprises bilateral internal attack angles. There is one attack angle measured between the leading auxiliary wheel 422a and the primary wheel 420, and a second attack angle measured between the leading auxiliary wheel 422b and the primary wheel 420. The attack angles are internal to the caster such that they are formed by lines that are tangential to the interior side of the caster 400 structure.

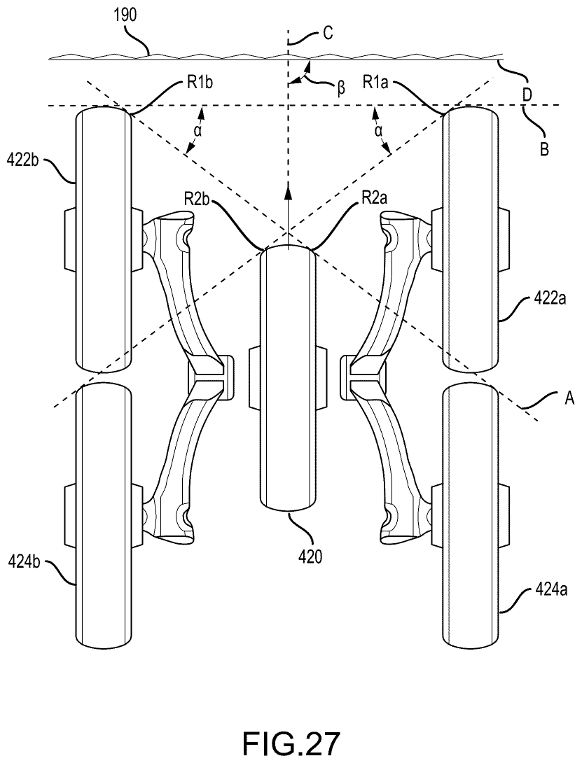

The attack angle α is a characteristic of the spatial relationship between the primary wheel 420 and auxiliary wheels of the caster 100. As shown in FIG. 27, the attack angle α can be defined as the included angle between a first reference line A connecting the primary wheel 420 and one of the leading auxiliary wheels 422a or 422b of a particular wheel set and a second reference line B extending parallel to the longitudinal axis 1000. The first reference line A can connect a first reference point Ria or Rib located on one of the leading auxiliary wheels 422a or 422b, and a second reference point R2a or R2b located on the primary wheel 420. The first reference point Ria or Rib is the forwardmost and innermost (i.e., closest spaced away from the fork 402) point of the leading auxiliary wheel 422. Similarly, the second reference point R2a is the forwardmost point of the primary wheel 120 that is on the opposite side of the second wheel set 401b. Similarly, the second reference point R2b is the forwardmost point of the primary wheel 120 that is on the opposite side of wheel set 401a. Reference points Ria and R2b form a first reference line A and reference points Rib and R2a for a second reference line A. Each wheel set 401a and 401b can for independent attack angles. In some embodiments, the first wheel set 401a and the second wheel set 401b have the same attack angle and in other embodiments the first wheel set 401a and the second wheel set 401b have different attack angles. Different configurations of the leading auxiliary wheels 422a and 422b and primary wheel 420 can alter the relationship between the first and second reference point R1a or Rib, R2a or R2b, thus altering the directionality of the first reference line A.

The casters described herein can be used in various combinations to provide different levels of maneuverability, pivotably, and ability to overcome obstacles. The combination of casters can be the same or different and the combination can be at least two casters, three casters, four casters, five casters, six casters, seven casters, or eight casters.

In some embodiments, a first caster and a second caster can have the construction of caster 300 described above, and a third caster and a fourth caster can have the construction of caster 100 described above. The four casters are arranged to form a rectangle when attached to the dolly structure or load 10 they will carry. The first caster and the second caster can form the front two casters (i.e., closer to the direction of travel) and are spaced equally from the center of the dolly structure or load 10. The third caster and the second caster can form the rear two casters (i.e., further to the direction of travel and are spaced equally from the center of the dolly structure or load 10. The first caster and second caster can be fixed and not rotatable about a king pin and the third caster and fourth caster can rotate about the king pin.

The casters described herein (100, 200, 300, and 400) can be made from various materials such as plastics, metal alloys, rubbers, composite materials, thermosets, thermoset resins, carbon fibers, fiber glasses or any other suitable material. The casters described herein (100, 200, 300, and 400) can be attached to a support structure by various means such as a post attachment inserted into a receiving geometry, a plate attachment that is bolted to the support structure, welded to the support structure, formed integral to the support structure.

The casters described herein (100, 200, 300, and 400) can be applied in different applications such as but not limited to single casters, dolly, furniture dolly, carts, creepers, hand trucks, or luggage.

### EXAMPLES

### 1. Example #1: Comparative Analysis of a Multi-Wheel Caster and a Standard Casters Across Varied Elevational Terrain

The objective of this example is to illustrate the capability of a multi-wheel caster compared to a standard caster in traversing various elevation changes while maintaining a loaded condition. This test was conducted by placing a load of 124.8 pounds on each caster and sliding each of the casters through different elevation changes (“bumps”). Each caster underwent six trials while the elevation of the bumps progressively increased.

The multi-wheel caster had a total weight of 10 lbs. The multi-wheel caster included four wheels with a 2.45 inch wheel diameter. The standard caster had a total weight of 8.6 lbs. The standard caster included one wheel with a 2.87 inch wheel diameter. Both casters had a center of gravity located at 36 inches when measured from the ground.

The first elevation change was tested at 0.25 inches, which represented 10.2% of the multi-wheel caster diameter and 8.7% of the standard caster diameter. The second elevation change was tested at 0.50 inches, which represented 20.4% of the multi-wheel caster diameter and 17.4% of the standard caster diameter. The third elevation change was tested at 0.75 inches, which represented 30.6% of the multi-wheel diameter and 26.1% of the standard caster diameter. The results were recorded in a “yes” and “no” manner, depicting if the caster successfully made it over the bump, or if it had a failed attempt in making it through the bump.

Furthermore, three velocities were measured from a slow motion video capture, using the front central wheel axle as the reference point. The first velocity was Vᵢₙᵢₜᵢₐₗ which was the initial velocity of each of the casters recorded before the cart impacted the bump. The second velocity was V_{impact} which was the recorded velocity of the cart during the impact with the bump. This velocity was V_{final} which was the recorded velocity of the cart after the impact with the bump. Finally, the average velocity drop was calculated by the following equation:

$$\% {V}_{drop} = \frac{{V}_{inital} - {V}_{impact}}{{V}_{inital}}$$

TABLE 1
Average Test Results

| | | | | | | | | Average |
|---|---|---|---|---|---|---|---|---|
| | | | | | Vᵢₙᵢₜᵢₐₗ | V_{impact} | V_{final} | velocity |
| Caster | Bump Height | | | | Average | Average | Average | drop |
| Standard | 0.25 inch bump | | | | 32.95 in/s | 7.7 in/s | 35.16 in/s | 77% ± 17% |
| Caster | | | | | | | | |
| Multi- | | | | | 35.6 in/s | 37.5 in/s | 47.38 in/s | −6% ± 4% |
| wheel | | | | | | | | |
| caster | | | | | | | | |
| Standard | 0.50 inch | Failed | Failed | Failed | 100% | | | |
| Caster | bump | attempt | attempt | attempt | | | | |
| Multi- | | | | | 44.65 in/s | 39.05 in/s | 60.51 in/s | 11% ± 12% |
| wheel | | | | | | | | |
| caster | | | | | | | | |
| Standard | 0.75 inch bump | | Failed | Failed | | Failed | 100% | |
| Caster | | | attempt | attempt | | attempt | | |
| Multi- | | | 50.7 in/s | 25.03 in/s | | 52.65 in/s | 51% ± 26% | |
| wheel | | | | | | | | |
| caster | | | | | | | | |

The results reflected that the standard caster had a higher number of failed attempts in overcoming the uneven terrain when compared to the multi-wheel caster. For the “0.25 inch bump”, the multi-wheel caster was successfully able to overcome the elevation change while in a loaded condition in all six attempts. On the other hand, the standard caster had an 83.300 success rate, as it made it over the bump five out of the six attempts, failing on the first trial.

Nonetheless, it was observed that the multi-wheel caster only had a −6%±4% average velocity drop, while the standard caster had a 77%±17% average velocity drop. This percentage could be attributed to the multi-wheel caster's ability to create a “lifting effect” that enables the caster to smoothly roll over uneven terrain. As the level arm rotates in response to discontinuities in the surface causing the auxiliary wheel to raise or lower to an active position. The active position of the auxiliary wheels reduces the deceleration of the central axle and the shock to the load when the caster encounters uneven terrain. This aligns with the conclusions of the trial, as the multi-wheel caster experienced a smaller amount of velocity change when compared to a standard caster.

For the “0.50 inch bump” the multi-wheel caster successfully traversed the elevation change for all six trials. On the other hand, the standard caster was not able to traverse the elevation change in any of the trials. At this elevation change, the multi-wheel caster experienced an 11%±12% average velocity drop. Moreover, the standard caster had a 100% average velocity drop which translated to the standard caster completely coming to a stop while attempting to traverse the elevation change.

For the “0.75 inch bump” the multi-wheel caster had a 90% success rate, as it made it over the bump five out of the six attempts, failing on the fourth trial. On the other hand, the standard caster was not able to traverse the elevation change in any of the trials. At this elevation change, the multi-wheel caster experienced a 51%±26% average velocity drop. Once again, the standard caster had a 100% average velocity drop which translated to the standard caster completely coming to a stop while attempting to traverse the elevation change.

This example thereby shows an improvement in the efficiency of the multi-wheel caster in non-ideal terrain conditions in comparison to a standard caster. Based on the results, it was shown that an initial velocity for the standard caster of 30 in/s or below would cause the standard caster to fail in its attempt. Conversely, the multi-wheel caster demonstrated that even at a velocity of 30 in/s or less, the multi-wheel caster was still able to overcome the elevation change. Furthermore, the multi-wheel caster showed a lower average velocity drop at higher elevation changes than those shown for the standard caster at the lowest elevation change. This makes the multi-wheel caster a more reliable option to use when transporting a load over non-ideal terrain conditions.

### 2. Example #2: Comparative Analysis of a Multi-Wheel Caster and a Standard Casters Across Varied Surface Gaps

The objective of this example is to illustrate the capability of a multi-wheel caster compared to a standard caster in traversing various surface gaps while maintaining a loaded condition. This test was conducted by placing a load of 124.8 pounds on each caster and sliding each of the casters through different surface gaps. Each caster underwent six trials while the width of the gaps progressively increased.

The multi-wheel caster had a total weight of 10 lbs. The multi-wheel caster included four wheels with a 2.45 inch wheel diameter. The standard caster had a total weight of 8.6 lbs. The standard caster included one wheel with a 2.87 inch wheel diameter. Both casters had a center of gravity located at 36 inches when measured from the ground.

The first surface gap had a total width of 1.0 inches. The second surface gap had a total width of 1.5 inches. The third surface gap had a total width of 2.0 inches. The fourth surface gap had a total width of 3.1 inches. The results were recorded in a “yes” and “no” manner, depicting if the caster successfully made it through the surface gap, or if it had a failed attempt in making it through the surface gap.

Furthermore, three velocities were measured from a slow motion video capture, using the front central wheel axle as the reference point. The first velocity was Vᵢₙᵢₜᵢₐₗ which was the initial velocity of each of the casters recorded before the cart impacted the bump. The second velocity was V_{impact} which was the recorded velocity of the cart during the impact with the bump. This velocity was V_{final} which was the recorded velocity of the cart after the impact with the bump. Finally, the average velocity drop was calculated by the following equation:

$$\% {V}_{drop} = \frac{{V}_{inital} - {V}_{impact}}{{V}_{inital}}$$

TABLE 2
Average Test Results

| | | | | | Average |
|---|---|---|---|---|---|
| Caster | Gap Width | Vᵢₙᵢₜᵢₐₗ Average | V_{impact} Average | V_{final} Average | velocity drop |
| Standard Caster | 1.0 inch gap | 39.4 in/s | 33.63 in/s | 46.58 in/s | 15% ± 10% |
| Multi-wheel | | 40.68 in/s | 40.58 in/s | 43.33 in/s | 0% ± 2% |
| caster | | | | | |
| Standard Caster | 1.5 inch gap | 41.53 in/s | 16.93 in/s | 53.93 in/s | 59% ± 10% |
| Multi-wheel | | 46.53 in/s | 46.5 in/s | 52.13 in/s | 0% ± 7% |
| caster | | | | | |
| Standard Caster | 2.0 inch gap | 47.76 in/s | 7.75 in/s | 19.95 in/s | 87% ± 26% |
| Multi-wheel | | 42.76 in/s | 40.1 in/s | 46.58 in/s | 7% ± 5% |
| caster | | | | | |
| Standard Caster | 3.1 inch gap | Not tested | Not tested | Not tested | Not tested |
| Multi-wheel | | 46.75 in/s | 35.35 in/s | 58 in/s | 25% ± 5% |
| caster | | | | | |

The results reflected that the standard caster had a higher number of failed attempts in rolling through the surface gaps when compared to the multi-wheel caster. For the “1.0 inch gap” both the multi-wheel caster and the standard caster were able to cruise through the surface gap in all six attempts. The standard caster experienced a 15%±10% velocity drop, while the multi-wheel caster experienced a 0%±2% velocity drop. Even though both types of casters were able to cruise over the surface gap, the standard caster still experienced a higher velocity drop than the multi-wheel caster when traversing the surface gap.

For the “1.5 inch gap” the multi-wheel caster successfully cruised through the surface gap in all six attempts. Conversely, the standard caster had a success rate of 83.3%, as it made it through the gap five out of six attempts, failing at the sixth trial. For this gap, the standard caster experienced a 59%±10% velocity drop, while the multi-wheel caster experienced a 0%±2% velocity drop.

For the “2.0 inch gap” the multi-wheel caster successfully cruised through the surface gap in all six attempts. Alternatively, the standard caster decreased to a 16.6% success rate, as it had five failed attempts. The standard caster was only able to make it through the gap on the fifth trial out of the six trials. For this gap, the standard caster experienced an 87%±26% velocity drop, while the multi-wheel caster experienced a 7%±5%.

Conclusively, for the “3.1 inch gap” the multi-wheel caster successfully cruised through the surface gap in all six attempts and experienced a 25%±5% velocity drop. Given the wheel dimensions of the standard caster, the trials were not conducted for this surface gap, as the standard caster would have fallen into the gap. This example thereby shows that having more than one wheel on a caster allows it to smoothly traverse gaps as well as providing more support to overcome larger gaps.

### Clauses

Clause 1: A caster for attachment to a support structure, the caster comprising: a wheel set, comprising: a level arm defining opposed first and second ends, and a central region disposed between the first and second ends; a first primary wheel rotatably coupled to the central region of the level arm; a first auxiliary wheel rotatably coupled to the first end of the level arm; and a second auxiliary wheel rotatably coupled to the second end of the level arm; a fork including: a first prong having a first prong lower end coupled to the level arm; and an upper seat coupled to the first prong; and a baseplate rotatably coupled to the upper seat of the fork and configured for attachment to the support structure.

Clause 2: The caster of clause 1, wherein the wheel set further comprises a second primary wheel rotatably coupled to the central region of the level arm.

Clause 3: The caster of clause 2, further comprising a central axle extending through a middle bore formed in the central region of the level arm, wherein each of the first primary wheel and the second primary wheel is rotatably coupled to the central axle.

Clause 4: The caster of clause 3, wherein the first auxiliary wheel and the second auxiliary wheel are rotatable coupled to the level arm via a first axle and a second axle.

Clause 5: The caster of clause 4, wherein the first auxiliary wheel and the second auxiliary wheel are rotatably coupled to a second level arm via the first axle and the second axle.

Clause 6: The caster of clause 5, wherein the first axle and the second axle are offset a distance D4 from the central axle, wherein D4 is greater than or equal to 0.03 inch and less than or equal to 0.12 inch.

Clause 7: The caster of clause 6, further comprising bearings disposed between the upper seat and the baseplate and a fastener for attaching the upper seat to the baseplate.

Clause 8: The caster of clause 7, wherein the baseplate further comprises mounting apertures.

Clause 9: The caster of clause 8, wherein the primary wheel and the first auxiliary wheel define an attack angle α between 30 and 60 degrees, wherein the attack angle comprises an included angle between a first reference line and a second reference line that extend parallel to a longitudinal axis, wherein the longitudinal axis runs through a middle bore center.

Clause 10: The caster of clause 9, wherein the level arm further comprises a stopping flange configured to engage the fork, thereby to prevent rotation of the level arm beyond a rotational limit.

Clause 11: The caster of clause 10, wherein the stopping flange extends perpendicular from a level arm first end.

Clause 12: The caster of clause 1, further comprising bearings disposed between the upper seat and the baseplate and a fastener for attaching the upper seat to the baseplate.

Clause 13: The caster of clause 1, wherein the baseplate further comprises mounting apertures.

Clause 14: The caster of clause 1, wherein the primary wheel and the first auxiliary wheel define an attack angle α between 30 and 60 degrees, wherein the attack angle comprises an included angle between a first reference line and a second reference line that extend parallel to a longitudinal axis, wherein the longitudinal axis runs through a middle bore center.

Clause 15: The caster of clause 1, wherein the level arm further comprises a stopping flange configured to engage the fork, thereby to prevent rotation of the level arm beyond a rotational limit.

Clause 16: The caster of clause 15, wherein the stopping flange extends perpendicular from a level arm first end.

Clause 17: The caster of clause 1, wherein the first auxiliary wheel is located approximately two thirds of the first auxiliary wheel diameter in front of the primary wheel.

Clause 18: The caster of clause 1, wherein the second auxiliary wheel is located approximately two thirds of the second auxiliary wheel diameter behind the primary wheel.

Clause 19: The caster of clause 1, wherein the first auxiliary wheel is located approximately one tenth of the first auxiliary wheel above the primary wheel.

Clause 20: The caster of clause 1, wherein the second auxiliary wheel is located approximately one tenth of the second auxiliary wheel diameter above the primary wheel.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A caster for attachment to a support structure, the caster comprising:
a wheel set, comprising:
a level arm defining opposed first and second ends, and a central region disposed between the first and second ends;
a first primary wheel rotatably coupled to the central region of the level arm;
a first auxiliary wheel rotatably coupled to the first end of the level arm; and
a second auxiliary wheel rotatably coupled to the second end of the level arm;
a fork including:
a first prong having a first prong lower end coupled to the level arm; and
an upper seat coupled to the first prong; and
a baseplate rotatably coupled to the upper seat of the fork and configured for attachment to the support structure.

2. The caster of claim 1, wherein the wheel set further comprises a second primary wheel rotatably coupled to the central region of the level arm.

3. The caster of claim 2, further comprising a central axle extending through a middle bore formed in the central region of the level arm, wherein each of the first primary wheel and the second primary wheel is rotatably coupled to the central axle.

4. The caster of claim 3, wherein the first auxiliary wheel and the second auxiliary wheel are rotatable coupled to the level arm via a first axle and a second axle.

5. The caster of claim 4, wherein the first auxiliary wheel and the second auxiliary wheel are rotatably coupled to a second level arm via the first axle and the second axle.

6. The caster of claim 5, wherein the first axle and the second axle are offset a distance D4 from the central axle, wherein D4 is greater than or equal to 0.03 inch and less than or equal to 0.12 inch.

7. The caster of claim 6, further comprising bearings disposed between the upper seat and the baseplate and a fastener for attaching the upper seat to the baseplate.

8. The caster of claim 7, wherein the baseplate further comprises mounting apertures.

9. The caster of claim 8, wherein the primary wheel and the first auxiliary wheel define an attack angle α between 30 and 60 degrees, wherein the attack angle comprises an included angle between a first reference line and a second reference line that extend parallel to a longitudinal axis, wherein the longitudinal axis runs through a middle bore center.

10. The caster of claim 9, wherein the level arm further comprises a stopping flange configured to engage the fork, thereby to prevent rotation of the level arm beyond a rotational limit.

11. The caster of claim 10, wherein the stopping flange extends perpendicular from a level arm first end.

12. The caster of claim 1, further comprising bearings disposed between the upper seat and the baseplate and a fastener for attaching the upper seat to the baseplate.

13. The caster of claim 1, wherein the baseplate further comprises mounting apertures.

14. The caster of claim 1, wherein the primary wheel and the first auxiliary wheel define an attack angle α between 30 and 60 degrees, wherein the attack angle comprises an included angle between a first reference line and a second reference line that extend parallel to a longitudinal axis, wherein the longitudinal axis runs through a middle bore center.

15. The caster of claim 1, wherein the level arm further comprises a stopping flange configured to engage the fork, thereby to prevent rotation of the level arm beyond a rotational limit.

16. The caster of claim 15, wherein the stopping flange extends perpendicular from a level arm first end.

17. The caster of claim 1, wherein the first auxiliary wheel is located approximately two thirds of the first auxiliary wheel diameter in front of the primary wheel.

18. The caster of claim 1, wherein the second auxiliary wheel is located approximately two thirds of the second auxiliary wheel diameter behind the primary wheel.

19. The caster of claim 1, wherein the first auxiliary wheel is located approximately one thirtieth of the first auxiliary wheel above the primary wheel.

20. The caster of claim 1, wherein the second auxiliary wheel is located approximately one thirtieth of the second auxiliary wheel diameter above the primary wheel.
